(19) United States
(12) Patent Application Publication
(10) Pub. No.: US 2007/0121183 A1
(43) Pub. Date: May 31, 2007

(54) Holographic device with hexagonal detector structure

(75) Inventor: Coen Liedenbaum, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/581,645

(22) PCT Filed: Nov. 25, 2004
(86) PCT No.: PCT/IB04/03917

§ 371 Date: Jun. 5, 2006

(30) Foreign Application Priority Data
Dec. 8, 2003 (EP) 03078841.8
Aug. 4, 2004 (EP) 04300514.9

(51) Int. Cl. G02B 5/32

(52) U.S. Cl. 359/21

(57) ABSTRACT

The invention relates to an optical holographic device for reading out a data page of a holographic medium (106). The holographic device comprises a pixelated detector (114) having detector elements organized in a staggered structure.

### FIELD OF THE INVENTION

The present invention relates to an optical holographic device for reading out a data page recorded in a holographic medium.

### BACKGROUND OF THE INVENTION

An optical device capable of recording on and reading from a holographic medium is known from H. J. Coufal, D. Psaltis, G. T. Sincerbox (Eds.), ‘Holographic data storage’, Springer series in optical sciences, (2000). FIG. 1 shows such an optical device. This optical device comprises a radiation source 100, a collimator 101, a first beam splitter 102, a spatial light modulator 103, a second beam splitter 104, a lens 105, a first deflector 107, a first telescope 108, a first mirror 109, a half wave plate 110, a second mirror 111, a second deflector 112, a second telescope 113 and a detector 114. The optical device is intended to record in and read data from a holographic medium 106.

During recording of a data page in the holographic medium, half of the radiation beam generated by the radiation source 100 is sent towards the spatial light modulator 103 by means of the first beam splitter 102. This portion of the radiation beam is called the signal beam. Half of the radiation beam generated by the radiation source 100 is deflected towards the telescope 108 by means of the first deflector 107. This portion of the radiation beam is called the reference beam. The signal beam is spatially modulated by means of the spatial light modulator 103. The spatial light modulator comprises transmissive areas and absorbent areas, which corresponds to zero and one data-bits of a data page to be recorded. After the signal beam has passed through the spatial light modulator 103, it carries the signal to be recorded in the holographic medium 106, i.e. the data page to be recorded. The signal beam is then focused on the holographic medium 106 by means of the lens 105.

The reference beam is also focused on the holographic medium 106 by means of the first telescope 108. The data page is thus recorded in the holographic medium 106, in the form of an interference pattern as a result of interference between the signal beam and the reference beam. Once a data page has been recorded in the holographic medium 106, another data page is recorded at a same location of the holographic medium 106. To this end, data corresponding to this data page are sent to the spatial light modulator 103. The first deflector 107 is rotated so that the angle of the reference signal with respect to the holographic medium 106 is modified. The first telescope 108 is used to keep the reference beam at the same position while rotating. An interference pattern is thus recorded with a different pattern at a same location of the holographic medium 106. This is called angle multiplexing. A same location of the holographic medium 106 where a plurality of data pages is recorded is called a book.

Alternatively, the wavelength of the radiation beam may be tuned in order to record different data pages in a same book. This is called wavelength multiplexing. Other kind of multiplexing, such as shift multiplexing, may also be used for recording data pages in the holographic medium 106.

During readout of a data page from the holographic medium 106, the spatial light modulator 103 is made completely absorbent, so that no portion of the beam can pass trough the spatial light modulator 103. The first deflector 107 is removed, such that the portion of the beam generated by the radiation source 100 that passes through the beam splitter 102 reaches the second deflector 112 via the first mirror 109, the half wave plate 110 and the second mirror 111. If angle multiplexing has been used for recording the data pages in the holographic medium 106, and a given data page is to be read out, the second deflector 112 is arranged in such a way that its angle with respect to the holographic medium 106 is the same as the angle that were used for recording this given hologram. The signal that is deflected by the second deflector 112 and focused in the holographic medium 106 by means of the second telescope 113 is thus the phase conjugate of the reference signal that were used for recording this given hologram. If for instance wavelength multiplexing has been used for recording the data pages in the holographic medium 106, and a given data page is to be read out, the same wavelength is used for reading this given data page.

The phase conjugate of the reference signal is then diffracted by the information pattern, which creates a reconstructed signal beam, which then reaches the detector 114 via the lens 105 and the second beam splitter 104. An imaged data page is thus created on the detector 114, and detected by said detector 114. The detector 114 comprises pixels or detector elements, each detector element corresponding to a bit of the imaged data page.

Usually, the spatial light modulator 103 comprises a square or rectangular structure with N row and M columns, where four closest transmissive or absorbent areas form a square or rectangle. As a consequence, the data bits recorded in a data page have the same square or rectangular structure as the spatial light modulator 103, because a data page recorded in the holographic medium 106 is an image of the spatial light modulator 103. Such a structure of the data bits in the recording medium leads to a relatively low data density.

Patent application WO03/034595 describes a method for increasing the data density of a holographic medium. According to this method, the data bits are recorded in a quasi-hexagonal lattice structure. However, this patent application does not describe how the data pages are read-out. According to the method described in this patent application, a multi-dimensional coding is used for recording the data pages. This means that the crosstalk between the individual data bits is taken into account when reading-out the data pages. The only way of implementing this method is to use a linear detector oriented in the direction of coding, and a large processing circuit for decoding the crosstalk between the detected data bits. Such a processing circuit is bulky, consumes a relatively high amount of power and is expensive. When the number of columns and rows of a data page is relatively high, such as 1000 columns and 1000 rows, it is therefore not realistic to use the method described in WO03/034595.

### SUMMARY OF THE INVENTION

It is an object of the invention to provide a holographic device which can read a holographic medium with an increased data density, wherein the amount of signal processing is not increased.

To this end, the invention proposes an optical holographic device for reading out a data page of a holographic medium, said holographic device comprising a pixelated detector having detector elements organized in a staggered structure.

According to the invention, the structure of the detector is modified so as to match the structure of the holographic medium. The use of a holographic medium with a staggered structure of the data bits increases the data density. The use of a pixelated detector which structure matches the staggered structure of the data page does not increase the signal processing with respect to a conventional holographic device. Actually, a data bit of a data page is imaged on an individual detector element of the pixelated detector, as is the case in holographic devices of the prior art where a square or rectangle structure of the data bits is used.

Advantageously, the staggered structure of the pixelated detector is a quasi-hexagonal structure. By a “quasi-hexagonal structure”, it should be understood a structure that is hexagonally arranged, but small distortions may be present. For instance, the angle between the axes of said structure may slightly differ from 60 degrees, for example such an angle may be between 55 and 65 degrees. As described in patent application WO03/034595, it is known from crystallography that hexagonal structures provide the highest data density. As a consequence, a holographic device in accordance with this advantageous embodiment is able to read-out holographic mediums having relatively high data densities.

These and other aspects of the invention will be apparent from and will be elucidated with reference to the embodiments described hereinafter.

### BRIEF DESCRIPTION OF THE DRAWINGS

The invention will now be described in more detail by way of example with reference to the accompanying drawings, in which:

FIG. 1 shows a holographic device in accordance with the prior art;

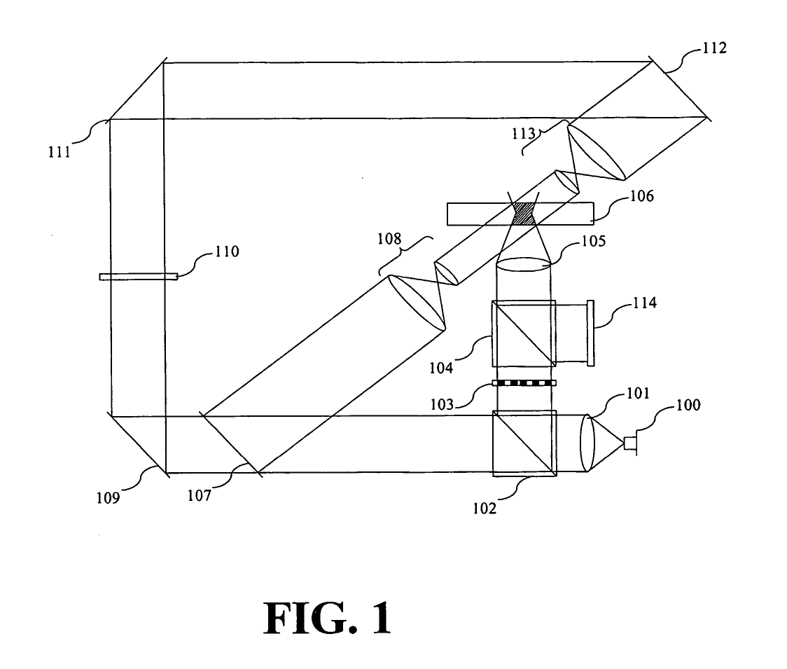

FIGS. 2a and 2b show a holographic medium and a detector in accordance with the prior art;

FIG. 3a and 3b show a holographic medium and a detector in accordance with the invention.

### DETAILED DESCRIPTION OF THE INVENTION

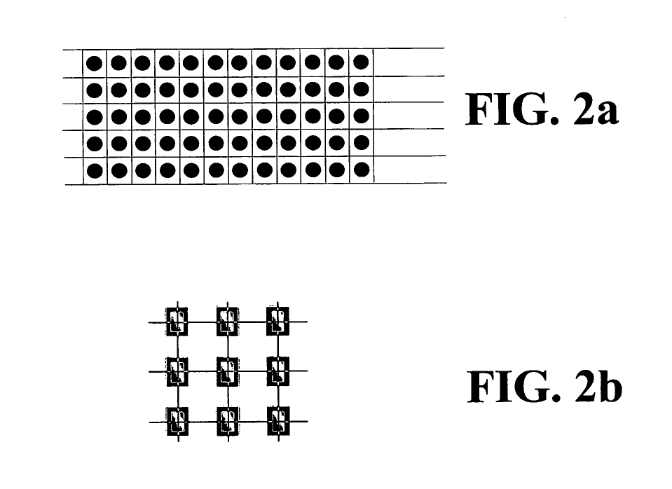

FIG. 2a diagrammatically shows a holographic medium in accordance with the prior art. A data page is shown, which comprises data bits that have been recorded by means of a spatial light modulator having transmissive and absorbent areas arranged in rows and columns distributed in a square structure. In this example, the data bits thus have a square structure. FIG. 2b diagrammatically shows the detector used for reading out this data page. The detector comprises pixels or detector elements, which are organised in a square structure. The data page is imaged on this detector in such a way that an imaged data bit impinges on an individual pixel of the detector.

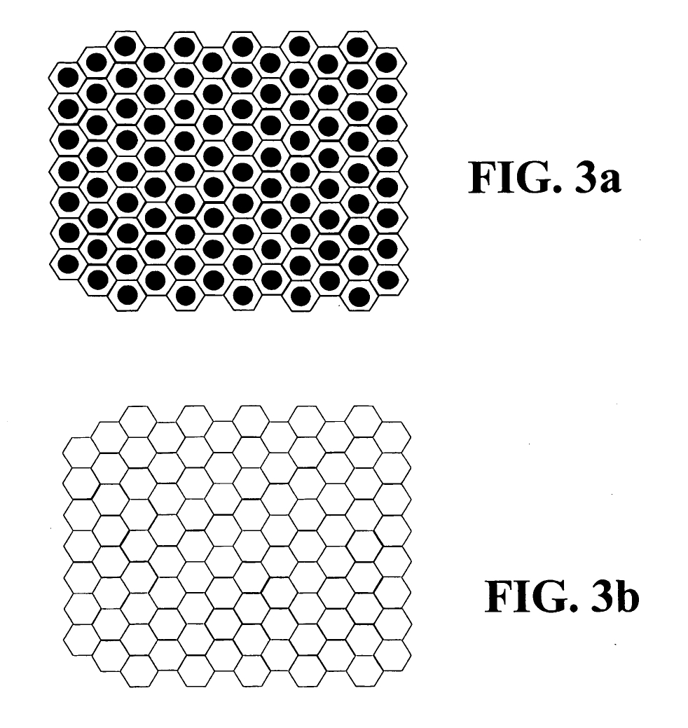

FIG. 3a diagrammatically shows a holographic medium intended to be read by a holographic device in accordance with the invention. A data page is shown, which comprises data bits organised in a staggered structure. Such a structure is also called a close-packed lattice structure. It is well known that the density of elements organised in a staggered structure is superior to the density of elements organised in a square or rectangle structure. Hence the density of data in the data page of FIG. 3a is superior to the data density in the data page of FIG. 2a.

FIG. 3b diagrammatically shows the detector used for reading out the data page of FIG. 3a. The detector comprises detector elements, which are also organised in a staggered structure. The data page is imaged on this detector in such a way that an imaged data bit impinges on an individual pixel of the detector. As a consequence, the signal processing after the detector is similar to the signal processing in a conventional holographic device with a square structure detector. Hence, the data density is increased while the complexity of signal processing is not increased.

Such a detector with a staggered structure is known from those skilled in the art. For example, the company Fuji commercializes such a detector under the name “super CCD”.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. An optical holographic device for reading out a data page of a holographic medium, said holographic device comprising a pixelated detector having detector elements organized in a staggered structure.

2. An optical holographic device as claimed in claim 1, wherein said structure is a quasi-hexagonal structure.
